(19) United States
(12) Patent Application Publication
(10) Pub. No.: US 2010/0182369 A1
(43) Pub. Date: Jul. 22, 2010

(54) METHOD OF AND APPARATUS FOR DETECTING DEFECTIVE NOZZLE OF PRTINER HEAD

(75) Inventors: Tatsuhiro Otsuka, Suwon-Si (KR); Ja-Nam Ku, Yongin-Si (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/632,169

(22) Filed: Dec. 7, 2009

(30) Foreign Application Priority Data
Jan. 16, 2009 (KR) 10-2009-0003752

(51) Int. Cl. B41J 29/38

(52) U.S. Cl. 347/19

(57) ABSTRACT

Disclosed are a method and an apparatus for detecting a defective nozzle of an inkjet print head. The method may include detecting a light transmitted through ink ejected from a nozzle of a print head, generating a signal associated with the detected light, amplifying the signal, and determining whether the nozzle is defective based on the amplified signal.

### CROSS-REFERENCE TO RELATED PATENT APPLICATION

This application claims the benefit of Korean Patent Application No. 10-2009-0003752, filed on Jan. 16, 2009, in the Korean Intellectual Property Office, the disclosure of which is incorporated herein by reference in its entirety.

### TECHNICAL FIELD

The present disclosure generally relates to a method and an apparatus for detecting a defective nozzle of an inkjet printer head.

### BACKGROUND OF RELATED ART

Generally, an inkjet printer, and more particularly, a color inkjet printer uses multiple ink cartridges, each of which cartridge may include on its bottom a printer head on which a large number of nozzles are formed. For example, a cartridge of the so-called a line printing type that has an array head spanning the entire width of the printing paper may include thousands of nozzles. With, such a large number of nozzles, there is a likelihood that some of the nozzles may be bad or defective due to manufacturing imprecision or defect during the mass production of such cartridges. A nozzle could also become blocked, defective or otherwise non-properly operable during use after the inkjet printer is placed in use due to various possible causes, e.g., the operating environment, problems in the internal circuitry of the printer, and the like. A nozzle that is bad, defective, or otherwise inoperative may adversely impact the quality of the printing. It is thus desirable to quickly and precisely detect such a defective nozzle for replacement.

### SUMMARY OF THE DISCLOSURE

According to an aspect of the present disclosure, there may be provided a method for detecting a defective nozzle of a print head, which method may include the steps of: detecting a light transmitted through ink ejected from a nozzle of the print head; generating a signal associated with the detected light; amplifying the signal; and determining whether the nozzle from the print head is defective based on the amplified signal.

The step of amplifying the signal may comprise amplifying the signal using a current/voltage amplifier and an amplifier, the amplifier being configured to amplify an output signal produced by the current/voltage amplifier based on a direct current (DC) voltage corresponding to the same DC level as the output signal of the current/voltage amplifier.

The step of amplifying the signal may further comprise: converting and amplifying by a first amplification stage using the current/voltage amplifier to produce a first amplified signal; amplifying the first amplified signal by a second amplification stage based on a DC voltage corresponding to the same DC level as the first amplified signal to produce a second amplified signal; and processing the second amplified signal using a slicer circuit to produce a square wave signal as the amplified signal.

When the square wave signal does not match a reference signal, the nozzle may be determined to be defective.

The reference signal may be a signal that may be detected from ink ejected by a reference nozzle of the print head that operates normally.

According to another aspect of the present disclosure, a computer-readable medium may be provided to have stored therein one or more computer executable instructions for implementing a method for detecting a bad nozzle of a print head, which method may comprise the steps of: detecting a light transmitted through ink ejected from a nozzle of the print head; generating a signal associated with the detected light; amplifying the signal; and determining whether the nozzle from the print head is defective based on the amplified signal.

According to yet another aspect, an apparatus for detecting a defective nozzle of a print head may be provided to comprise a photodiode, an amplifier and a defective nozzle detection unit. The photodiode may be configured to detect light transmitted through ink ejected from a nozzle of the print head, and may be configured to produce a signal associated with the detected light. The amplifier may be configured to amplify the signal produced by the photodiode to produce an amplified signal. The defective nozzle detection unit may be configured to detect whether the nozzle is defective based on the amplified signal.

The amplifier may comprise a first amplifier and a second amplifier. The first amplifier may be a current/voltage amplifier that is configured to convert the signal from current to voltage. The second amplifier may be configured to amplify an output signal produced by the first amplifier based on a DC voltage corresponding to the same DC level as the output signal of the first amplifier.

The amplifier may comprise a current/voltage amplifier, a voltage amplifier and a slicer circuit. The current/voltage amplifier may be configured to convert a current of the signal produced by the photodiode into a voltage. The voltage amplifier may have a first input terminal and a second input terminal, and may be configured to receive a signal output produced by the current/voltage amplifier at the first input terminal as an input signal and to receive a DC voltage corresponding to the same DC level as the signal output produced by the current/voltage amplifier at the second input terminal. The voltage amplifier may further be configured to amplify the input signal based on the DC voltage. The slicer circuit may be configured to receive a first input signal output by the voltage amplifier and a second input signal that is generated by performing a low-pass filtering on the first input signal, and to produce a square wave signal based on the received first and second input signals.

The current/voltage amplifier may further be configured to amplify the voltage produced by the conversion from the current to the voltage.

The defective nozzle detection unit may be configured to determine that the nozzle is defective when the amplified signal does not match a reference signal.

The reference signal may be a signal that is detected from ink ejected by a reference nozzle of the print head that operates normally.

According to even yet another aspect of the present disclosure, a method of detecting a defective nozzle of a print head of an inkjet printer nay be provided to include the steps of: performing a plurality of ink droplet ejections in succession from a nozzle of the print head; observing the plurality of ink droplet ejections with an optical sensor to produce an observed signal pattern corresponding a plurality of ink droplets ejected during the plurality of ink droplet ejections; comparing the observed signal pattern with a reference signal pattern; and determining whether the nozzle of the print head is defective based on the comparison of the observed signal pattern with the reference signal pattern.

The method may further comprise the steps of: producing by the optical sensor a signal output in response to the observation of the plurality of ink droplets; amplifying the signal output to produce an amplified signal; and processing the amplified signal to produce a square wave having the observed signal pattern.

The step of amplifying the signal output may comprise the steps of: converting a current signal output by the optical sensor into a voltage signal; and amplifying the voltage signal in such a manner to at least partially remove a direct current (DC) component of the voltage signal to produce the amplified signal.

The step of processing the amplified signal may comprise performing a low-pass filtering on the amplified signal.

The optical sensor may comprise a photodiode configured to detect light passing through the plurality of ink droplets.

The reference signal pattern may comprise a signal pattern observed from a known good nozzle that is known to operate properly.

Each of the reference signal pattern and the observed signal pattern may comprise a binary bit pattern.

The observed signal pattern includes an indication of a magnitude of the signal output of the optical sensor.

### BRIEF DESCRIPTION OF THE DRAWINGS

Various aspects and advantages of the present disclosure will become apparent and more readily appreciated from the following description of several embodiments thereof, taken in conjunction with the accompanying drawings, in which:

FIG. 1 is a block diagram of an apparatus for detecting a bad nozzle of a printer head according to an embodiment of the present disclosure;

FIG. 2 is a diagram illustrative of a signal detected by a photodiode according to an embodiment of the present disclosure;

FIG. 3 is a diagram showing an amplification processing unit according to an embodiment of the present disclosure; and

FIG. 4 is a flowchart of a method of detecting a bad nozzle of a printer head according to an embodiment of the present disclosure.

### DETAILED DESCRIPTION OF THE INVENTION

Reference will now be made in detail to several embodiments, examples of which are illustrated in the accompanying drawings, wherein like reference numerals refer to like elements throughout. While the embodiments are described with detailed construction and elements to assist in a comprehensive understanding of the various applications and advantages of the embodiments, it should be apparent however that the embodiments may be carried out without those specifically detailed particulars. Also, well-known functions or constructions will not be described in detail so as to avoid obscuring the description with unnecessary detail. It should be also noted that in the drawings, the dimensions of the features are not intended to be to true scale and may be exaggerated for the sake of allowing greater understanding.

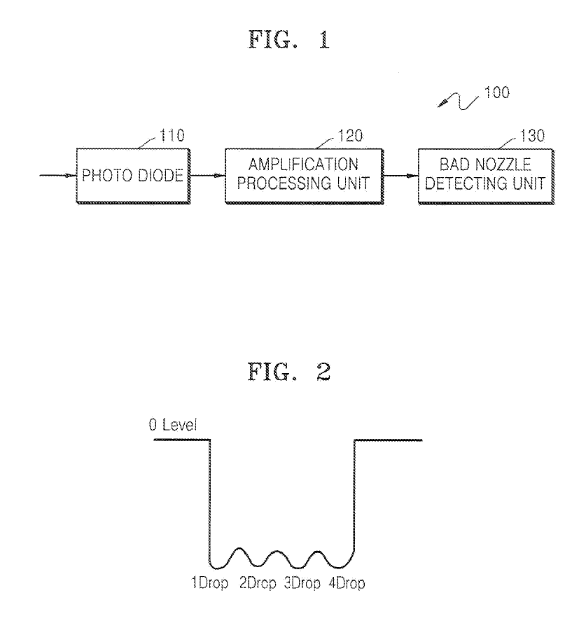

FIG. 1 is a block diagram of an apparatus for detecting a bad nozzle of a printer head according to an embodiment of the present disclosure. The apparatus 100 according to an embodiment may include a photodiode 110, an amplification processing unit 120 and a bad nozzle detection unit 130.

The photodiode 110 may be configured to detect light transmitted through the ink ejected from one or more nozzles of a printer head. The photodiode 110 may be configured to output a current signal corresponding to the detected light. In other words, the current signal produced by the photodiode 110 may be proportional to the amount of light detected. According to an embodiment of the present disclosure, when a light emitting unit (not shown) emits or produces light, the light that is emitted may be transmitted through the ink ejected from a nozzle, and the photodiode 110 may detect the light transmitted through the ink. According to an embodiment, a photodiode 110 and light emitting unit pair may be disposed under each of the nozzles of a printer head. After ink is initially ejected from a nozzle, a more or lesser amount of ink than the amount of ink in the initial ejection may be successively ejected from the nozzle. Therefore, the magnitude of the output current signals may potentially change every time that light transmitted through ink ejected from a nozzle is detected by the photodiode 110.

An example of the signal produced by the photodiode according to an embodiment is illustrated in FIG. 2. Referring to FIG. 2, prior to, and without, an ink ejection, the photodiode 110 detects the light from the light emitting unit directly unobstructed by the ink, and thus may output a current signal at an initial level indicated as ‘0 Level.’ Subsequently, in response to the ejection of the initial ink droplet from a nozzle, the photodiode associated with the nozzle may detect a less amount of light owing to the light being obscured by the ink, and thus may output a current signal of reduced magnitude as indicated by the signal labelled ‘1Drop.’ When one or more additional ink droplets are ejected in sufficiently quick succession from the same nozzle, the amount of the light detected by the photodiode may not return to the original unobstructed level, resulting in the small fluctuation of the current signal output by the photodiode as illustrated in FIG. 2. According to an embodiment, multiple ink ejections may be performed by a nozzle, and may be detected by the photodiode 110 in order to test a nozzle's proper operability. For example, the signal shown in FIG. 2, in which four droplets of ink have been ejected from a nozzle in quick succession, may correspond to an example of the output signal that may be produced by the photodiode 110. While the magnitude of the signal shown in FIG. 2 is exaggerated for illustrative purposes, the actual magnitude of a signal produced by the photodiode 110, particularly the fluctuations or ripples representing the successive ink droplets, may be relatively small. As a result, the output signal produced by the photodiode 100 may need to be amplified in order to analyze or to identify the signal.

Referring back to FIG. 1, and as will be further described in greater detail, the amplification processing unit 120 may be configured to receive the current signals output by the photodiode 110, and may amplify the received current signals by using, for example, a current/voltage amplifier (not shown in FIG. 1) to convert the current signals to voltage signals. The amplification processing unit 120 according to an embodiment may also include an amplifier (not shown in FIG. 1) configured to amplify the output of the current/voltage amplifier based on a direct current (DC) voltage corresponding to the same DC voltage level as the output of the current/voltage amplifier so that an amplified signal, that corresponds to the fluctuation, e.g., an alternating current (AC) component, of the photodiode output.

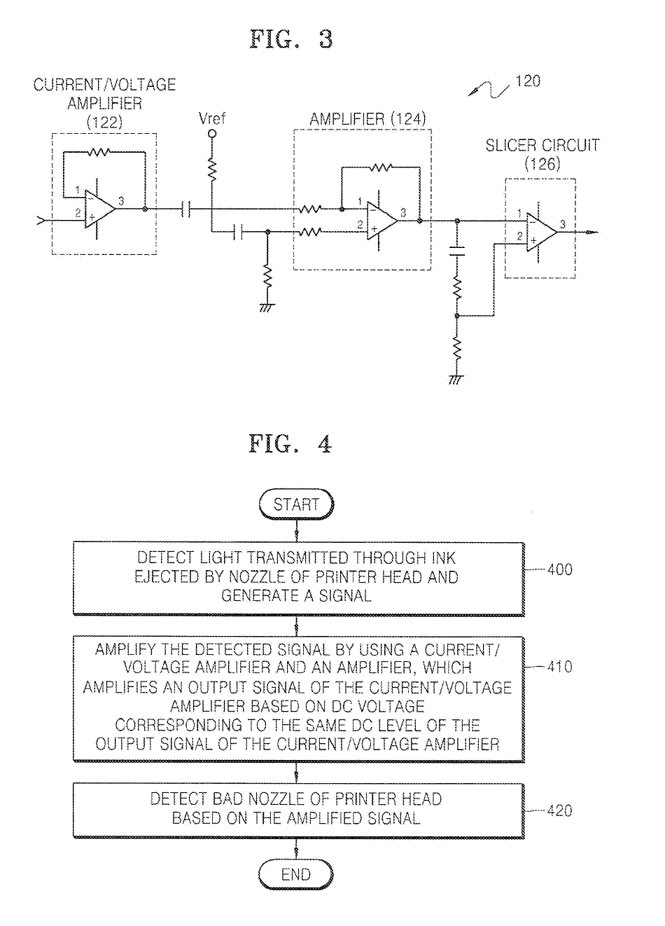

FIG. 3 is a diagram that shows details of an example of the amplification processing unit 120 of FIG. 1 according to an embodiment of the present disclosure.

As shown in FIG. 3, the amplification processing unit 120 according to an embodiment may include a current/voltage amplifier 122, an amplifier 124 and a slicer circuit 126. The current/voltage amplifier 122 may be configured to convert current signals that are provided as an input to the amplification processing unit 120 from the photodiode 110 into voltage signals. In some embodiments, the current/voltage amplifier 122 may also be configured to amplify with certain gain the voltage signals that are produced as a result of the current-to-voltage conversion.

The voltage signal output produced by the current/voltage amplifier 122 may then be provided as an input to the first input terminal of the amplifier 124. A voltage Vref may be applied that results in a DC voltage that is at the same DC voltage level as the signal output produced by the current/voltage amplifier 122 being provided as an input to the second input terminal of the amplifier 124. Because the voltage Vref is input to the second input terminal of the amplifier 124 through the circuit that is connected to the ground through a capacitor and a resistor, the voltage at the second input terminal of the amplifier 124 is for the most part a DC voltage. The amplifier 124 may thus amplify the signal input provided via the first input terminal based on the DC voltage input provided via the second input terminal of the differential amplifier so as to output an amplified signal that represents the fluctuation portion (e.g., the fluctuation or ripple corresponding to the 1Drop, 2Drop, 3Drop and 4Drop portion of the four successive ink droplet ejections example shown in FIG. 2) of the output of the photodiode.

The amplified signal output produced by the amplifier 124 may further be provided as an input to a first input terminal of the slicer circuit 126, and a signal generated by performing a low-pass filtering on the signal output produced by the amplifier 124 may be provided as an input to a second input terminal of the slicer circuit 126. Because the second input terminal of the slicer circuit 126 may be connected to a low-pass filter including a capacitor and a resistor, the signal output produced by the amplifier 124 may be filtered by the low-pass filter prior to being provided as an input to the second input terminal of the slicer circuit 126. Consequently, the slicer circuit 126 may produce an output signal that is a square wave.

Referring back to FIG. 1, the bad nozzle detection unit 130 may be configured to detect bad nozzles of a printer head based on the signals amplified and/or processed by the amplification processing unit 120. For example, when a signal produced by the amplification processing unit 120 does not match a reference signal that would be detected from a properly operational nozzle (i.e., a known good nozzle) of a printer head, the bad nozzle detection unit 130 may determine that the nozzle associated with such signal is defective. According to an embodiment of the present disclosure, the reference signal, i.e., the signal that is expected to be detected from a properly functioning nozzle, may be obtained empirically from a known good nozzle of the print head, and may be stored in a storage device (not shown) in advance.

FIG. 4 is a flowchart of an example of a method of detecting a bad nozzle of a printer head according to an embodiment of the present disclosure. Referring to FIG. 4, in operation 400, light transmitted through ink ejected from, a nozzle of a printer head may be detected by the photodiode 110. According to an embodiment, a light emitting unit emits light and a photodiode (e.g., photodiode 110) may detect the amount of light transmitted through the ink ejected from the nozzle of the printer head, and may output a signal associated with the detected light. According to an embodiment, the signal output produced by the photodiode 110 may have the form of the waveform shown in FIG. 2. In other embodiments, the signal output produced by the photodiode 110 may be different from that shown in FIG. 2.

In operation 410, the detected signal may be amplified by using a current/voltage amplifier (e.g., the current/voltage amplifier 122), and an amplifier (e.g., the amplifier 124) that amplifies the output signal of the current/voltage amplifier based on a DC voltage corresponding to the same DC level as the output signal of the current/voltage amplifier. For example, the detected signal produced by the photodiode 110 may be converted and amplified by a first amplification stage provided by the current/voltage amplifier 122, and the first amplified signal may be further amplified by a second amplification stage including the amplifier 124 based on a DC voltage corresponding to the same DC voltage level as the first amplified signal. Moreover, the second amplified signal may be provided as an input to a slicer circuit (e.g., the slicer circuit 126), which processes the signal to produce a square wave signal output.

In operation 420, a bad nozzle of a printer head may be detected based, on the square wave signal produced by the slicer circuit. When the amplified square wave signal does not match with a reference signal normally detected from ink ejected by a properly operational nozzle of the printer head, the nozzle associated with such amplified square wave signal may be determined to be a bad nozzle. According to an embodiment of the present disclosure, the reference signal or the signature pattern of a known good nozzle may be obtained in advance empirically, for example, under the same test condition of ejecting ink droplets in the same sequence, and may be stored for use as a reference. According to an embodiment, the comparison of the test waveforms with the reference waveform may concern only the switching pattern of the waveforms without regard to the variations in the amplitude. For example, the compared waveforms may each be represented as a binary or otherwise digital value pattern of ones and zeros. In alternative embodiments, the magnitudes of the waveforms may additionally be compared, and, when the magnitudes of the waveforms of compared signals are different, the associated nozzle may still be determined to be a bad nozzle even when the waveforms of the compared signals have similar patterns.

The defective nozzle detection according to the embodiments herein described may be performed during manufacture as a part of testing for manufacturing defect or at the field by the inkjet printer for detecting nozzles that have become inoperable during use. The embodiments of the present disclosure may be implemented as computer programs, and may be stored in a computer readable recording medium for execution by a controller, processor or a general purpose computer. Examples of the computer readable recording medium may include memory devices (e.g., random access memory, read-only-memory, Flash memory, and the like), magnetic storage media (e.g., ROM, floppy disks, hard disks, and the like) and optical recording media (e.g., CD-ROMs, DVDs, and the like).

Although several embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A method for detecting a defective nozzle of a print head, comprising:
detecting a light transmitted through ink ejected from a nozzle of the print head;
generating a signal associated with the detected light;
amplifying the signal; and
determining whether the nozzle from the print head is defective based on the amplified signal.

2. The method of claim 1, wherein the step of amplifying the signal comprises:
amplifying the signal using a current/voltage amplifier and an amplifier, the amplifier being configured to amplify an output signal produced by the current/voltage amplifier based on a direct current (DC) voltage corresponding to the same DC level as the output signal of the current/voltage amplifier.

3. The method of claim 2, wherein the step of amplifying the signal further comprises:
converting and amplifying by a first amplification stage using the current/voltage amplifier to produce a first amplified signal;
amplifying the first amplified signal by a second amplification stage based on a DC voltage corresponding to the same DC level as the first amplified signal to produce a second amplified signal; and
processing the second amplified signal using a slicer circuit to produce a square wave signal as the amplified signal.

4. The method of claim 3, wherein, when the square wave signal does not match a reference signal, the nozzle is determined to be defective.

5. The method of claim 4, wherein the reference signal is a signal detected from ink ejected by a reference nozzle of the print head that operates normally.

6. A computer-readable medium having stored therein one or more computer executable instructions for implementing a method for detecting a bad nozzle of a print head, the method comprising:
detecting a light transmitted through ink ejected from a nozzle of the print head;
generating a signal associated with the detected light;
amplifying the signal; and
determining whether the nozzle from the print head is defective based on the amplified signal.

7. An apparatus for detecting a defective nozzle of a print head, comprising:
a photodiode configured to detect light transmitted through ink ejected from a nozzle of the print head and to produce a signal associated with the detected light;
an amplifier configured to amplify the signal produced by the photodiode to produce an amplified signal; and
a defective nozzle detection unit configured to detect whether the nozzle is defective based on the amplified signal.

8. The apparatus of claim 7, wherein the amplifier comprises:
a first amplifier and a second amplifier, the first amplifier being a current/voltage amplifier configured to convert the signal from current to voltage, the second amplifier being configured to amplify an output signal produced by the first amplifier based on a DC voltage corresponding to the same DC level as the output signal of the first amplifier.

9. The apparatus of claim 7, wherein the amplifier comprises:
a current/voltage amplifier configured to convert a current of the signal produced by the photodiode into a voltage;
a voltage amplifier having a first input terminal and a second input terminal, the voltage amplifier being configured to receive a signal output produced by the current/voltage amplifier at the first input terminal as an input signal and to receive a DC voltage corresponding to the same DC level as the signal output produced by the current/voltage amplifier at the second input terminal, the voltage amplifier being further configured to amplify the input signal based on the DC voltage; and
a slicer circuit configured to receive a first input signal output by the voltage amplifier and a second input signal that is generated by performing a low-pass filtering on the first input signal, and to produce a square wave signal based on the received first and second input signals.

10. The apparatus of claim 9, wherein the current/voltage amplifier is further configured to amplify the voltage produced by the conversion from the current to the voltage.

11. The apparatus of claim 7, wherein the defective nozzle detection unit is configured to determine that the nozzle is defective when the amplified signal does not match a reference signal.

12. The apparatus of claim 11, wherein the reference signal is a signal detected from ink ejected by a reference nozzle of the print head that operates normally.

13. A method of detecting a defective nozzle of a print head of an inkjet printer, comprising:
performing a plurality of ink droplet ejections in succession from a nozzle of the print head;
observing the plurality of ink droplet ejections with an optical sensor to produce an observed signal pattern corresponding a plurality of ink droplets ejected during the plurality of ink droplet ejections;
comparing the observed signal pattern with a reference signal pattern; and
determining whether the nozzle of the print head is defective based on the comparison of the observed signal pattern with the reference signal pattern.

14. The method of claim 13, further comprising:
producing by the optical sensor a signal output in response to the observation of the plurality of ink droplets;
amplifying the signal output to produce an amplified signal; and
processing the amplified signal to produce a square wave having the observed signal pattern.

15. The method of claim 14, wherein the step of amplifying the signal output comprises:
converting a current signal output by the optical sensor into a voltage signal; and
amplifying the voltage signal in such a mariner to at least partially remove a direct current (DC) component of the voltage signal to produce the amplified signal.

16. The method of claim 14, wherein the step of processing the amplified signal comprises:
performing a low-pass filtering on the amplified signal.

17. The method of claim 13, wherein the optical sensor comprises a photodiode configured to detect light passing through the plurality of ink droplets.

18. The method of claim 13, wherein the reference signal pattern comprises a signal pattern observed from a known good nozzle that is known to operate properly.

19. The method of claim 13, wherein each of the reference signal pattern and the observed signal pattern comprises a binary bit pattern.

20. The method of claim 14, wherein the observed signal pattern includes an indication of a magnitude of the signal output of the optical sensor.
